(19) United States
(12) Patent Application Publication
(10) Pub. No.: US 2013/0189993 A1
(43) Pub. Date: Jul. 25, 2013

(54) CELL RESELECTION METHOD AND USER EQUIPMENT

(71) Applicant: HUAWEI TECHNOLOGIES CO., LTD., Shenzhen (CN)

(72) Inventors: Lufeng HAN, Beijing (CN); Tao LIU, Beijing (CN)

(73) Assignee: HUAWEI TECHNOLOGIES CO., LTD., Shenzhen (CN)

(21) Appl. No.: 13/720,579

(22) Filed: Dec. 19, 2012

(30) Foreign Application Priority Data
Jan. 19, 2012 (CN) 201210017757.2

(51) Int. Cl. H04W 36/08

(52) U.S. Cl. CPC H04W 36/08
USPC 455/437

(57) ABSTRACT

Embodiments of the present invention disclose a cell reselection method and a user equipment, and the method includes: receiving, by a user equipment UE, a system message sent by a base station, where the system message includes a domain identifier of a neighboring cell of a source cell accesses by the UE, where the domain identifier is a routing area RA or location area LA or tracking area TA of the neighboring cell, the source cell is controlled by the base station, and there is at least one neighboring cell; judging, whether the domain identifier of the neighboring cell belongs to an RA or LA or TA in a camping forbidden list in the UE; and keeping the UE camping on the source cell if the domain identifier of the neighboring cell belongs to the RA or LA or TA in the camping forbidden list in the UE.

### CROSS-REFERENCE TO RELATED APPLICATIONS

This application claims priority to Chinese Patent Application No. 201210017757.2, filed on Jan. 19 2012, which is hereby incorporated by reference in its entirety.

### FIELD OF THE INVENTION

The present invention relates to the field of communications technologies, and in particular, to a cell reselection method and a user equipment.

### BACKGROUND OF THE INVENTION

The 3GPP (The 3rd Generation Partnership Project, the 3rd generation partnership project) is a 3rd generation technical specification which is based on a GSM (Global System of Mobile Communication, global system of mobile communication) core network, and uses a UTRAN (UMTS Terrestrial Radio Access Network, UMTS terrestrial radio access network) as a wireless interface, an LTE (Long Term Evolution, long term evolution) network evolved by the 3GPP can coexist with other existing networks, and due to coexistence of different networks, different services may be provided for a user according to a demand of the user.

For example, when a UE (User Equipment, user equipment) camps on the LTE network, an LTE access network sends a system message to the UE, and notifies the UE of information of a neighboring cell of a source cell on which the UE currently camps; and the UE measures the neighboring cell, where if the neighboring cell meets a reselection criterion, the UE reselects to camp on the neighboring cell; and the UE parses system information of the neighboring cell, and judges whether the UE meets a camping condition of the neighboring cell, and if the UE does not meet the camping condition of the neighboring cell, the UE returns to and camps on the source cell.

The prior art has the following problem:

A UE first needs to reselect to temporarily camps on a neighboring cell of a source cell, only after the UE completes parsing system information of the neighboring cell on which the UE temporarily camps, it can be determined whether the UE can camp on the neighboring cell, and if the UE cannot camp on the neighboring cell, the UE needs to return to and camp on the source cell, so that this migration process reduces cell reselection efficiency, and wastes a wireless resource.

### SUMMARY OF THE INVENTION

Embodiments of the present invention provide a cell reselection method and a user equipment, so that whether a neighboring cell can be camped on can be judged in a source cell, thereby improving cell reselection efficiency, and saving a wireless resource.

The technical solutions adopted in the embodiments of the present invention are as follows.

A cell reselection method includes:

receiving, by a user equipment UE, a system message sent by a base station, where the system message includes a domain identifier of a neighboring cell of a source cell accessed by the UE, the domain identifier is an RA (Routing Area, routing area) or LA (Location Area, location area) or TA (Tracking Area, tracking area) of the neighboring cell, the source cell is controlled by the base station, and there is at least one neighboring cell;

judging, by the UE, whether the domain identifier of the neighboring cell belongs to an RA or LA or TA in a camping forbidden list in the UE; and

keeping the UE camping on the source cell if the domain identifier of the neighboring cell belongs to the RA or LA or TA in the camping forbidden list in the UE.

A cell reselection method includes:

receiving, by a user equipment UE, a system message sent by a base station, where the system message includes measurement information, a public land mobile network identifier (PLMNID), and a domain identifier of a neighboring cell of a source cell accessed by the UE, the domain identifier is a routing area RA or location area LA or tracking area TA of the neighboring cell, the source cell is controlled by the base station, and there is at least one neighboring cell;

measuring, by the UE, the neighboring cell according to the measurement information, and obtaining signal quality of the neighboring cell;

selecting, according to the PLMNID, from the neighboring cell, a cell which belongs to an equivalent operator with the source cell and whose signal quality is better than that of the source cell as a cell to be measured, and judging, by the UE, whether a domain identifier of the cell to be measured belongs to an RA or LA or TA in a camping forbidden list in the UE; and

keeping the UE camping on the source cell if the domain identifier of the cell to be measured belongs to the RA or LA or TA in the camping forbidden list in the UE.

A user equipment includes:

a first receiving module, configured to receive a system message sent by a base station, where the system message includes a domain identifier of a neighboring cell of a source cell accessed by the UE, the domain identifier is a routing area RA or location area LA or tracking area TA of the neighboring cell, the source cell is controlled by the base station, and there is at least one neighboring cell;

a first judging module, configured to judge whether the domain identifier of the neighboring cell belongs to an RA or LA or TA in a camping forbidden list in the UE, where the domain identifier of the neighboring cell is included in the system message; and

a first keeping module, configured to keep the UE camping on the source cell if the domain identifier of the neighboring cell belongs to the RA or LA or TA in the camping forbidden list in the UE.

A user equipment includes:

a second receiving module, configured to receive a system message sent by a base station, where the system message includes measurement information, a public land mobile network identifier PLMNID, and a domain identifier of a neighboring cell of a source cell accessed by the UE, the domain identifier is a routing area RA or location area LA or tracking area TA of the neighboring cell, the source cell is controlled by the base station, and there is at least one neighboring cell;

a second measuring module, configured to measure the neighboring cell according to the measurement information, and obtain signal quality of the neighboring cell;

a second judging module, configured to select, according to the PLMNID, from the neighboring cell, a cell which belongs to an equivalent operator with the source cell and whose signal quality is better than that of the source cell as a cell to be measured, and judge whether a domain identifier of the cell to be measured belongs to an RA or LA or TA in a camping forbidden list in the UE; and

a second keeping module, configured to keep the UE camping on the source cell if the domain identifier of the cell to be measured belongs to the RA or LA or TA in the camping forbidden list in the UE.

By adopting the technical solutions of the present invention, whether a neighboring cell can be camped on may be judged in a source cell, and compared with the prior art, cell reselection efficiency is improved, and a wireless resource is saved.

### BRIEF DESCRIPTION OF THE DRAWINGS

To illustrate the technical solutions in the embodiments of the present invention more clearly, the accompanying drawings required for describing the embodiments or the prior art are introduced briefly in the following. Apparently, the accompanying drawings in the following description merely show some embodiments of the present invention, and persons of ordinary skill in the art may also derive other drawings from these accompanying drawings without creative efforts.

FIG. 1 is a flow chart of a cell reselection method according to Embodiment 1 of the present invention;

FIG. 2 is a flow chart of a cell reselection method according to Embodiment 2 of the present invention;

FIG. 3 is a flow chart of a cell reselection method according to Embodiment 3 of the present invention;

FIG. 4 is a flow chart of a cell reselection method according to Embodiment 4 of the present invention;

FIG. 5 and FIG. 6 are schematic structural diagrams of a user equipment according to Embodiment 5 of the present invention; and

FIG. 7 and FIG. 8 are schematic structural diagrams of a user equipment according to Embodiment 6 of the present invention.

### DETAILED DESCRIPTION OF THE EMBODIMENTS

The technical solutions in the embodiments of the present invention are described clearly and completely in the following with reference to the accompanying drawings in the embodiments of the present invention. Apparently, the embodiments in the following description are merely a part rather than all of the embodiments of the present invention. Based on the embodiments of the present invention, all other embodiments obtained by persons of ordinary skill in the art without creative effects shall fall within the protection scope of the present invention.

To make the advantages of the technical solutions of the present invention more comprehensible, the present invention is described in detail in the following with reference to the accompanying drawings and embodiments.

### Embodiment 1

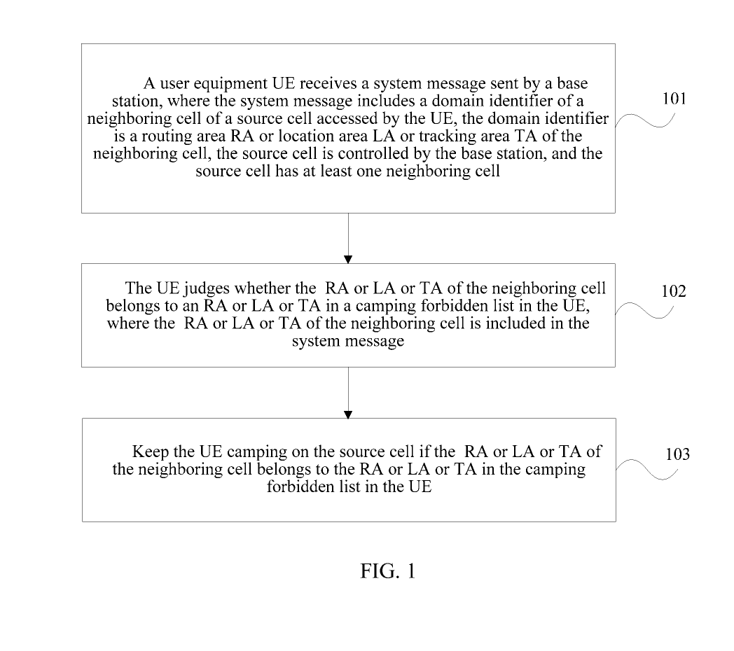

As shown in FIG. 1, Embodiment 1 of the present invention provides a cell reselection method, and the cell reselection method includes:

101: A user equipment UE receives a system message sent by a base station, where the system message includes a domain identifier of a neighboring cell of a source cell accessed by the UE, the domain identifier is a routing area RA or location area LA or tracking area TA of the neighboring cell, the source cell is controlled by the base station, and there is at least one neighboring cell.

102: The UE judges whether the domain identifier of the neighboring cell belongs to an RA or LA or TA in a camping forbidden list in the UE, where the domain identifier of the neighboring cell is included in the system message.

103: Keep the UE camping on the source cell if the domain identifier of the neighboring cell belongs to the RA or LA or TA in the camping forbidden list in the UE.

It should be noted that, a LA location area is a concept in a circuit domain at a GSM age and UMTS age, a location area is a location area currently registered by a terminal, which is recorded in an MSC/VLR, and when calling the terminal, a network first finds, through an HLR, an MSC/VLR where the terminal is located, and then finds, in the MSC/VLR, an LA location area where the terminal is located, and sends a paging message to all base stations in the LA location area.

A TA is a location area in an LTE packet domain. In the LTE, it is mainly a data service, and when downlink data exists in a network, a PGW delivers the data to an SGW, and then the SGW triggers an MME, to initiate paging, the MME searches a tracking area list TAI LIST where a UE is located, where the tracking area list TAI LIST is stored in a memory, and then delivers the paging to a terminal.

An RA routing area is used to indicate a current location of a terminal in a current system in the GPRS, which may be understood as a subset of the LA. In a GPRS core network, an SGSN is responsible for managing a routing area, a serving area that can be provided by the SGSN is formed by several RAs, an RA is formed by several cells, and one cell can belong to only one routing area.

In the camping forbidden list in the UE, RA, LA, or TA information is information which is returned by a core network to the UE in a process of registering with the core network when the UE accesses the base station initially.

It should be further noted that, for neighboring cells of different networks, when it is judged whether a camping criterion is met, parameters in a required RA, LA, or TA are different, for example, for an LTE network, it is required to judge whether the camping forbidden list in the UE includes a TA of the neighboring cell; and for a UTRAN and GSM network, it is required to judge whether the camping forbidden list in the UE includes an RA or LA of the neighboring cell.

In this embodiment, the system message further includes measurement information and a public land mobile network identifier PLMNID of the neighboring cell, where the measurement information includes a cell identifier, a carrier frequency, and duration that the UE accesses a cell; and if the domain identifier of the neighboring cell does not belong to the RA or LA or TA in the camping forbidden list in the UE, a cell which belongs to an equivalent operator with the source cell is selected, according to the PLMNID, from the neighboring cell as a cell to be measured, and the cell to be measured is measured according to the measurement information, so as to obtain signal quality of the cell to be measured.

Further, after measuring the cell to be measured, and obtaining the signal quality of the cell to be measured, the method further includes: a cell to be measured, signal quality of which is better than that of the source cell and is the best, is determined as a target cell, and the UE reselects the target cell and camps on the target cell.

It should be noted that, the UE performs cell reselection to obtain a service with a better signal condition from other peripheral networks. In the prior art, when the UE camps on a current cell of a network, for example, the network of the current cell is an LTE network, through a system message sent by an access network to the UE, the current cell is notified which neighboring cells exist, and some parameters such as a cell identifier and a carrier frequency that are required for measuring signal quality of these neighboring cells are sent to the UE, the UE measures the signal quality of these neighboring cells, selects a cell whose signal quality is better, to temporarily camps on, and judges whether a TA of the cell meets a condition for the UE to camp on the cell, where if the condition is met, the UE camps on the cell; and if the condition is not met, the UE returns to and camps on a previous LTE cell.

Compared with the prior art, in this embodiment of the present invention, when a user equipment UE is in a source cell, the UE can judge in advance whether a domain identifier of a neighboring cell of the source cell belongs to an RA or LA or TA in a camping forbidden list in the UE, so as to judge whether the UE can camp on the neighboring cell of the source cell, and does not need to, like the prior art, temporarily camp on the neighboring cell first, and then parse a system message of the neighboring cell to judge whether the neighboring cell can be camped on, and if the neighboring cell cannot be camped on, the UE further needs to return to and camp on the source cell. By adopting the technical solutions in the embodiment of the present invention, cell reselection efficiency is improved, and a wireless resource is saved.

### Embodiment 2

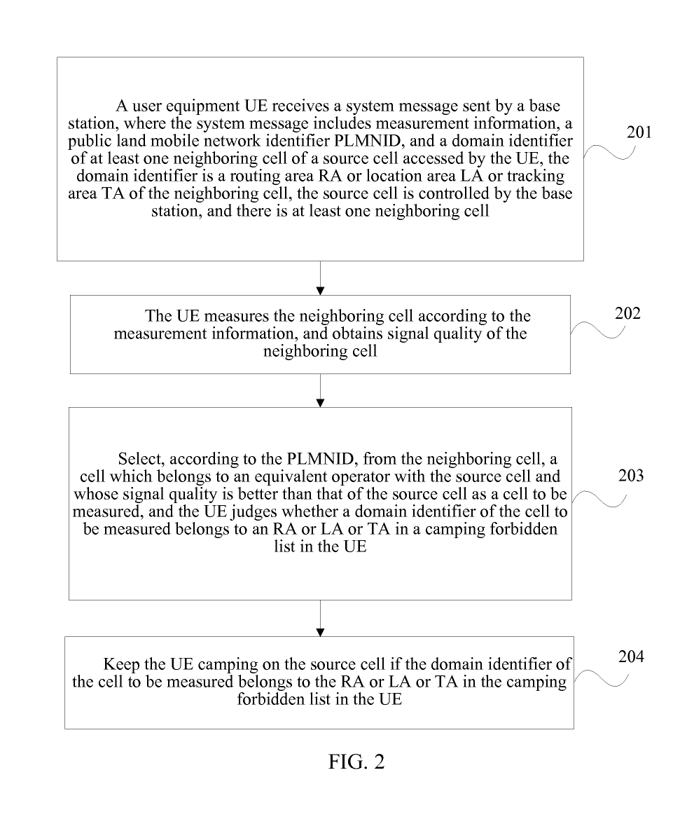

As shown in FIG. 2, Embodiment 2 of the present invention provides a cell reselection method, and the method includes:

201: A user equipment UE receives a system message sent by a base station, where the system message includes measurement information, a public land mobile network identifier PLMNID, and a domain identifier of at least one neighboring cell of a source cell accessed by the UE, the domain identifier is a routing area RA or location area LA or tracking area TA of the neighboring cell, the source cell is controlled by the base station, and there is at least one neighboring cell.

202: The UE measures the neighboring cell according to the measurement information, and obtains signal quality of the neighboring cell.

203: Select, according to the PLMNID, from the neighboring cell, a cell which belongs to an equivalent operator with the source cell and whose signal quality is better than that of the source cell as a cell to be measured, and the UE judges whether a domain identifier of the cell to be measured belongs to an RA or LA or TA in a camping forbidden list in the UE.

204: Keep the UE camping on the source cell if the domain identifier of the cell to be measured belongs to the RA or LA or TA in the camping forbidden list in the UE.

It should be noted that, in the camping forbidden list in the UE, RA, LA, or TA information is information which is returned by a core network to the UE in a process of registering with the core network when the UE accesses the base station initially.

It should be further noted that, for neighboring cells of different networks, when it is judged whether a camping criterion is met, parameters in a required RA, LA, or TA are different, for example, for an LTE network, it is required to judge whether the camping forbidden list in the UE includes a TA of the neighboring cell; and for a UTRAN and GSM network, it is required to judge whether the camping forbidden list in the UE includes an RA or LA of the neighboring cell.

In this embodiment of the present invention, further, if the domain identifier of the cell to be measured does not belong to the RA or LA or TA in the camping forbidden list in the UE, the UE uses a cell, signal quality of which is the best in the cell to be measured, as a target cell, and the UE reselects the target cell and camps on the target cell.

Compared with the prior art, in this embodiment of the present invention, when a user equipment UE is in a source cell, the UE first selects a cell to be measured from a neighboring cell of the source cell, and then judges whether a domain identifier of the cell to be measured belongs to an RA or LA or TA in a camping forbidden list in the UE, so as to judge whether the UE can camp on the cell to be measured, thereby improving cell reselection efficiency, and saving a wireless resource.

### Embodiment 3

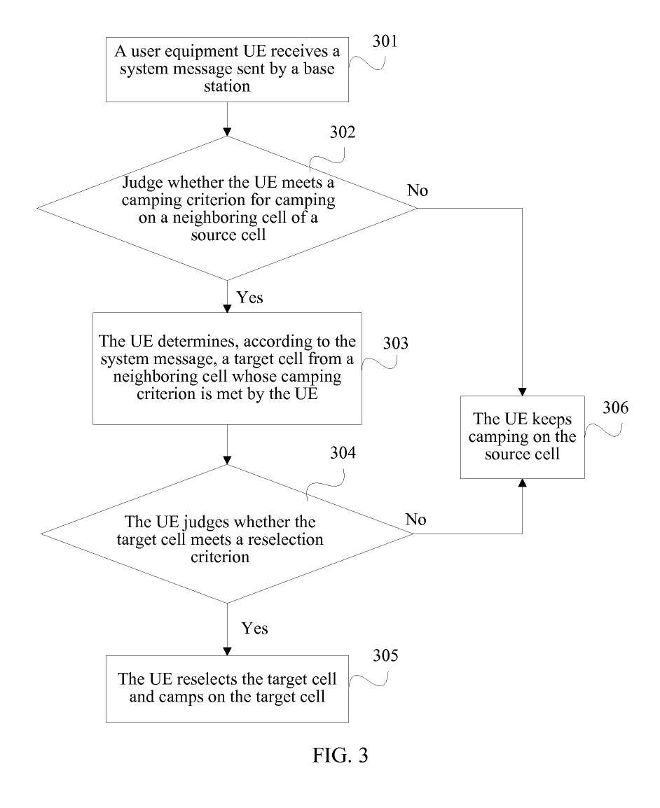

This embodiment provides a cell reselection method, and as shown in FIG. 3, the method includes:

301: A user equipment UE receives a system message sent by a base station.

The system message includes: a public land mobile network identifier PLMNID, measurement information, and a domain identifier of a neighboring cell of a source cell accessed by the UE, where the domain identifier is a routing area RA or location area LA or tracking area TA of the neighboring cell, the source cell is controlled by the base station, and there is at least one neighboring cell, and the measurement information includes a cell identifier, a carrier frequency, duration that the UE accesses a cell, and the like.

302: Judge whether the UE meets a camping criterion for camping on the neighboring cell of the source cell. If the UE meets the camping criterion for camping on the neighboring cell, perform step 303; and if the UE does not meet the camping criterion for camping on the neighboring cell, perform step 306.

Specifically, compare the domain identifier of the neighboring cell with an RA or LA or TA in a camping forbidden list in the UE, where the domain identifier of the neighboring cell is included in the system message; if the camping forbidden list in the UE does not include the domain identifier of the neighboring cell, the UE meets the camping criterion for camping on the neighboring cell; and if the camping forbidden list in the UE includes the domain identifier of the neighboring cell, the UE does not meet the camping criterion for camping on the neighboring cell. In the camping forbidden list in the UE, RA, LA, or TA information is information which is returned by a core network to the UE in a process of registering with the core network when the UE accesses the base station initially.

Specifically, for neighboring cells of different networks, when it is judged whether a camping criterion is met, it is required to judge different parameters in a domain identifier; for an LTE network, it is required to judge whether the camping forbidden list in the UE includes a TA of the neighboring cell; and for a UTRAN and GSM network, it is required to judge whether the camping forbidden list in the UE includes an RA or LA of the neighboring cell.

303: The UE determines, according to the system message, a cell to be measured from a neighboring cell whose camping criterion is met by the UE.

The UE determines, according to a public land mobile network identifier and measurement information of the neighboring cell, a cell which is to be measured and camped on, where the public land mobile network identifier and measurement information of the neighboring cell are included in the system message. The public land mobile network identifier PLMNID is used to judge whether a certain neighboring cell belongs to a cell of an equivalent operator of the source cell accesses by the UE, where if a certain cell does not belong to the cell of the equivalent operator of the source cell, the cell is not considered as a cell to be measured, and if a certain cell belongs to the cell of the equivalent operator of the source cell, the cell is used as a cell to be measured.

The UE measures, according to the measurement information of the neighboring cell, the cell to be measured, and specifically, evaluates signal quality of the cell to be measured according to the cell identifier, the carrier frequency, and the duration that the UE accesses a cell, and determines a cell to be measured, signal quality of which is better than that of the source cell and is the best, as a target cell.

304: The UE judges whether the target cell meets a reselection criterion, where if the target cell meets the reselection criterion, perform step 305; and if the target cell does not meet the reselection criterion, perform step 306.

Specifically, judge whether signal quality of the target cell meets a cell preset threshold specified in the reselection criterion, where if the signal quality of the target cell is greater than or equal to the preset threshold, it indicates that the target cell meets the reselection criterion, and if the signal quality of the target cell is smaller than the preset threshold, it indicates that the target cell does not meet the reselection criterion. The preset threshold is set according to signal quality of the source cell and signal quality of the neighboring cell of the source cell.

305: The UE reselects the target cell and camps on the target cell.

306: The UE keeps camping on the source cell.

Compared with the prior art, in this embodiment of the present invention, according to information of domain identifier of a neighboring cell of a source cell, where the information of the domain identifier of the neighboring cell is included in a system message sent by a base station, and the domain identifier is an RA or LA or TA of the neighboring cell, when a UE is in the source cell, the UE can judge whether the domain identifier of the neighboring cell of the source cell belongs to an RA or LA or TA in a camping forbidden list in the UE, so as to judge whether the UE can camp on the neighboring cell of the source cell, so that a case that the UE reselects a neighboring cell of a certain source cell but cannot camp on the neighboring cell, and returns to and camps on the source cell again is avoided, thereby improving cell reselection efficiency and saving a wireless resource at the same time.

### Embodiment 4

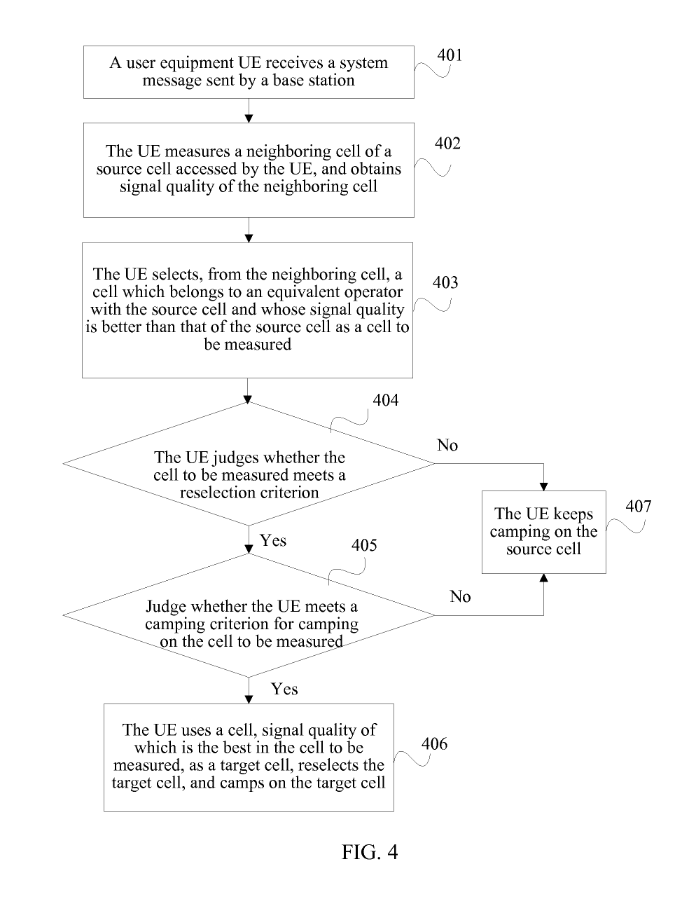

This embodiment provides a cell reselection method, and as shown in FIG. 4, the method includes:

401: A user equipment UE receives a system message sent by a base station.

The system message includes: a public land mobile network identifier PLMNID, measurement information, and a domain identifier of a neighboring cell of a source cell accessed by the UE, where the domain identifier is a routing area RA or location area LA or tracking area TA of the neighboring cell, the source cell is controlled by the base station, and there is at least one neighboring cell, and the measurement information includes a cell identifier, a carrier frequency, duration that the UE accesses a cell, and the like.

402: The UE measures, according to the measurement information included in the system message, a neighboring cell of a source cell accessed by the UE, and obtains signal quality of the neighboring cell.

403: The UE selects, according to the PLMNID included in the system message, from the neighboring cell, a cell which belongs to an equivalent operator with the source cell and whose signal quality is better than that of the source cell as a cell to be measured.

404: The UE judges whether the cell to be measured meets a reselection criterion, where if the cell to be measured meets the reselection criterion, perform step 405; and if the cell to be measured does not meet the reselection criterion, perform step 407.

Specifically, judge whether signal quality of the cell to be measured meets a cell preset threshold specified in the reselection criterion, where if the signal quality of the cell to be measured is greater than or equal to the preset threshold, it indicates that the cell to be measured meets the reselection criterion, and if the signal quality of the cell to be measured is smaller than the preset threshold, it indicates that the cell to be measured does not meet the reselection criterion. The preset threshold is set according to signal quality of the source cell and signal quality of the neighboring cell of the source cell.

405: Judge whether the UE meets a camping criterion for camping on the cell to be measured. If the UE meets the camping criterion for camping on the cell to be measured, perform step 406; and if the UE does not meet the camping criterion for camping on the cell to be measured, perform step 407.

Specifically, compare domain identifier information of the cell to be measured in the neighboring cell with an RA or LA or TA in a camping forbidden list in the UE, where the domain identifier information of the cell to be measured is included in the system message; if the camping forbidden list in the UE does not include the domain identifier information of the cell to be measured, the UE meets the camping criterion for camping on the cell to be measured; and if the camping forbidden list in the UE includes the domain identifier information of the cell to be measured, the UE does not meet the camping criterion for camping on the cell to be measured. In the camping forbidden list in the UE, RA, LA, or TA information is information which is returned by a core network to the UE in a process of registering with the core network when the UE accesses the base station initially.

Specifically, for different networks, when it is judged whether a camping criterion is met, it is required to judge different parameters in a domain identifier; for an LTE network, it is required to judge whether the camping forbidden list in the UE includes a TA of the neighboring cell; and for a UTRAN and GSM network, it is required to judge whether the camping forbidden list in the UE includes an RA or LA of the neighboring cell.

406: The UE uses a cell, signal quality of which is the best in the cell to be measured, as a target cell, reselects the target cell, and camps on the target cell.

407: The UE keeps camping on the source cell.

Compared with the prior art, in this embodiment of the present invention, a UE selects, according to a system message sent by a base station, a cell to be measured from a neighboring cell of a source cell accesses by the UE, and when the UE is in the source cell, the UE judges whether a domain identifier of the cell to be measured belongs to an RA or LA or TA in a camping forbidden list in the UE, so as to judge whether the UE can camp on the cell to be measured, so that a case that the UE reselects a neighboring cell of a certain source cell but cannot camp on the neighboring cell, and returns to and camps on the source cell again is avoided, thereby improving cell reselection efficiency and saving a wireless resource at the same time.

### Embodiment 5

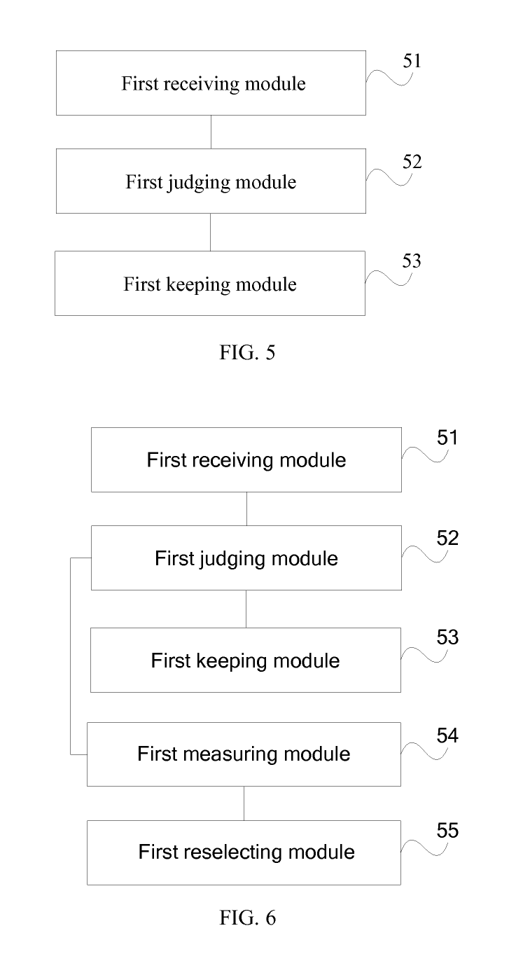

This embodiment provides a user equipment, and as shown in FIG. 5, the user equipment includes:

a first receiving module 51, configured to receive a system message sent by a base station, where the system message includes a domain identifier of a neighboring cell of a source cell accessed by the UE, the domain identifier is a routing area RA or location area LA or tracking area TA of the neighboring cell, the source cell is controlled by the base station, and there is at least one neighboring cell;

a first judging module 52, configured to judge whether the domain identifier of the neighboring cell belongs to an RA or LA or TA in a camping forbidden list in the UE, where the domain identifier of the neighboring cell is included in the system message; and

a first keeping module 53, configured to keep the UE camping on the source cell if the domain identifier of the neighboring cell belongs to the RA or LA or TA in the camping forbidden list in the UE.

In this embodiment, the system message received by the first receiving module 51 further includes measurement information and a public land mobile network identifier PLMNID of the neighboring cell, where the measurement information includes a cell identifier, a carrier frequency, and duration that the UE accesses a cell.

Further, as shown in FIG. 6, the user equipment further includes:

a first measuring module 54, configured to: when the domain identifier of the neighboring cell does not belong to the RA or LA or TA in the camping forbidden list in the UE, select, according to the PLMNID, from the neighboring cell, a cell which belongs to an equivalent operator with the source cell as a cell to be measured, and measure, according to the measurement information, the cell to be measured, so as to obtain signal quality of the cell to be measured; and

a first reselecting module 55, configured to determine a cell whose signal quality is better than that of the source cell and is the best in the cell to be measured as a target cell, and reselect the target cell and camp on the target cell.

Compared with the prior art, in this embodiment of the present invention, according to domain identifier information of a neighboring cell of a source cell, where the domain identifier information of the neighboring cell is included in a system message that is sent by a base station, when a UE is in the source cell, the user equipment UE can judge whether a domain identifier of the neighboring cell of the source cell belongs to an RA or LA or TA in a camping forbidden list in the UE, so as to judge whether the UE can camp on the neighboring cell of the source cell, so that a case that the UE reselects a neighboring cell of a certain source cell but cannot camp on the neighboring cell, and returns to and camps on the source cell again is avoided, thereby improving cell reselection efficiency and saving a wireless resource at the same time.

### Embodiment 6

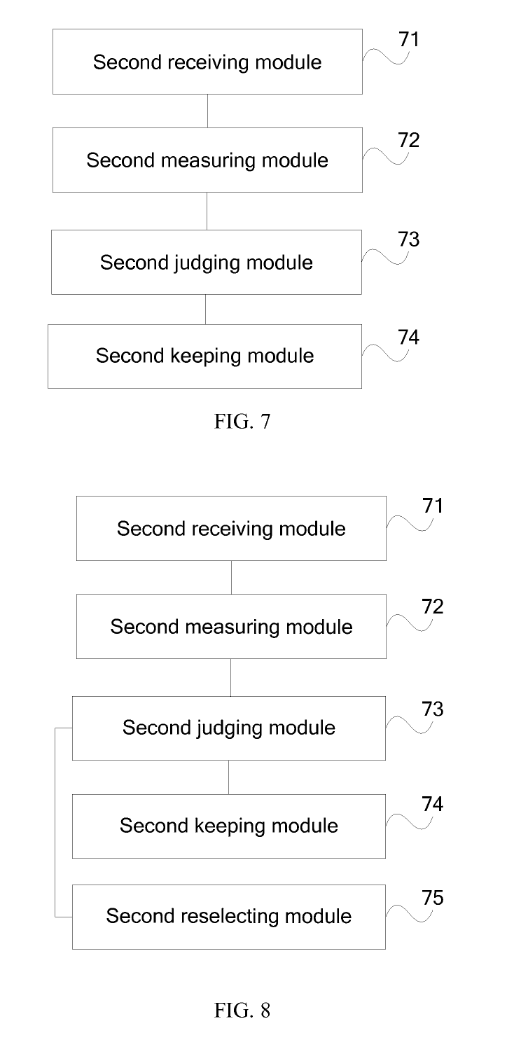

This embodiment provides a user equipment, and as shown in FIG. 7, the user equipment includes:

a second receiving module 71, configured to receive a system message sent by a base station, where the system message includes measurement information, a public land mobile network identifier PLMNID, and a domain identifier of a neighboring cell of a source cell accessed by the UE, the domain identifier is a routing area RA or location area LA or tracking area TA of the neighboring cell, the source cell is controlled by the base station, and there is at least one neighboring cell;

a second measuring module 72, configured to measure the neighboring cell according to the measurement information, and obtain signal quality of the neighboring cell;

a second judging module 73, configured to select, according to the PLMNID, from the neighboring cell, a cell which belongs to an equivalent operator with the source cell and whose signal quality is better than that of the source cell as a cell to be measured, and judge whether a domain identifier of the cell to be measured belongs to an RA or LA or TA in a camping forbidden list in the UE; and

a second keeping module 74, configured to keep the UE camping on the source cell if the domain identifier of the cell to be measured belongs to the RA or LA or TA in the camping forbidden list in the UE.

Further, as shown in FIG. 8, the user equipment further includes:

a second reselecting module 75, configured to: when the domain identifier of the cell to be measured does not belong to the RA or LA or TA in the camping forbidden list in the UE, use a cell, signal quality of which is the best in the cell to be measured, as a target cell, and reselect the target cell and camp on the target cell.

Compared with the prior art, in this embodiment of the present invention, a UE selects, according to a system message sent by a base station, a cell to be measured from a neighboring cell of a source cell accesses by the UE, and when the UE is in the source cell, the UE judges whether a domain identifier of the cell to be measured belongs to an RA or LA or TA in a camping forbidden list in the UE, so as to judge whether the UE can camp on the cell to be measured, so that a case that the UE reselects a neighboring cell of a certain source cell but cannot camp on the neighboring cell, and returns to and camps on the source cell again is avoided, thereby improving cell reselection efficiency and saving a wireless resource at the same time.

With the cell reselection method and the user equipment provided in the embodiments of the present invention, the foregoing method embodiments may be implemented. For specific functions, reference may be made to the description of the method embodiments, which are not described here again. The cell reselection method and the user equipment provided in the embodiments of the present invention are applicable to reselection of a user equipment between cells, but are not limited here.

Persons of ordinary skill in the art may understand that all or a part of the procedures of the methods in the embodiments may be implemented by a computer program instructing relevant hardware. The program may be stored in a computer readable storage medium. When the program runs, the procedures of the method in the embodiments are performed. The storage medium may be a magnetic disk, an optical disk, a read-only memory (Read-Only Memory, ROM), a random access memory (Read-Only Memory, RAM), and the like.

The foregoing descriptions are merely specific embodiments of the present invention, but are not intended to limit the protection scope of the present invention. Any variation or replacement easily figured out by persons skilled in the art within the technical scope disclosed in the present invention shall all fall within the protection scope of the present invention. Therefore, the protection scope of the present invention shall be subject to that of the claims.

1. A cell reselection method, comprising:
receiving, by a user equipment (UE), a system message sent by a base station, wherein the system message comprises a domain identifier of a neighboring cell of a source cell accessed by the UE, the domain identifier is one of the group consisting of a routing area (RA), a location area (LA) and a tracking area (TA) of the neighboring cell, the source cell is controlled by the base station, and there is at least one neighboring cell;
judging, by the UE, whether the domain identifier of the neighboring cell belongs to one of the group consisting of an RA, and an LA and a TA in a camping forbidden list in the UE; and
keeping the UE camping on the source cell if the domain identifier of the neighboring cell belongs to one of the group consisting of the RA, the LA, and the TA in the camping forbidden list in the UE.

2. The cell reselection method according to claim 1, wherein the system message further comprises measurement information and a public land mobile network identifier (PLMNID) of the neighboring cell, and the measurement information comprises a cell identifier, a carrier frequency, and duration that the UE accesses a cell, and
if (a) the domain identifier of the neighboring cell does not belong to one of the group consisting of the RA, the LA, and the TA in the camping forbidden list in the UE, and (b) according to the PLMNID, a cell which belongs to an equivalent operator with the source cell is selected from the neighboring cell as a cell to be measured, then the cell to be measured is measured according to the measurement information, so as to obtain signal quality of the cell to be measured.

3. The cell reselection method according to claim 2, wherein after the step of measuring the cell to be measured, so as to obtain the signal quality of the cell to be measured, the method further comprises:
determining a cell, signal quality of which is better than that of the source cell and is the best in the cells to be measured, as a target cell, and reselecting, by the UE, the target cell and camping on the target cell.

4. A cell reselection method, comprising:
receiving, by a user equipment (UE), a system message sent by a base station, wherein the system message comprises measurement information, a public land mobile network identifier (PLMNID), and a domain identifier of a neighboring cell of a source cell accessed by the UE, the domain identifier is one of the group consisting of a routing area (RA), a location area (LA), and a tracking area (TA) of the neighboring cell, the source cell is controlled by the base station, and there is at least one neighboring cell;
measuring, by the UE, the neighboring cell according to the measurement information, and obtaining signal quality of the neighboring cell;
selecting, according to the PLMNID, from the neighboring cell, a cell which belongs to an equivalent operator with the source cell and whose signal quality is better than that of the source cell as a cell to be measured, and judging, by the UE, whether a domain identifier of the cell to be measured belongs to one of the groups consisting of an RA, and an LA, and a TA in a camping forbidden list in the UE; and
keeping the UE camping on the source cell if the domain identifier of the cell to be measured belongs to one of the group consisting of the RA the LA and the TA in the camping forbidden list in the UE.

5. The cell reselection method according to claim 4, further comprising:
if the domain identifier of the cell to be measured does not belong to one of the group consisting of the RA, the LA, and the TA in the camping forbidden list in the UE, using, by the UE, a cell, signal quality of which is the best in the cells to be measured, as a target cell, and reselecting, by the UE, the target cell and camping on the target cell.

6. A user equipment, comprising:
a receiving module, configured to receive a system message sent by a base station, wherein the system message comprises a domain identifier of a neighboring cell of a source cell accessed by the UE, the domain identifier is one of the group consisting of a routing area (RA), a location area (LA), and a tracking area (TA) of the neighboring cell, the source cell is controlled by the base station, and there is at least one neighboring cell;
a judging module, configured to judge whether the domain identifier of the neighboring cell belongs to one of the group consisting of an RA, and an LA, and a TA in a camping forbidden list in the UE, wherein the domain identifier of the neighboring cell is comprised in the system message; and
a keeping module, configured to keep the UE camping on the source cell if the domain identifier of the neighboring cell belongs to one of the group consisting of the RA the LA and the TA in the camping forbidden list in the UE.

7. The user equipment according to claim 6, wherein the system message received by the receiving module further comprises measurement information and a public land mobile network identifier (PLMNID) of the neighboring cell, and the measurement information comprises a cell identifier, a carrier frequency, and duration that the UE accesses a cell.

8. The user equipment according to claim 7, further comprising:
a measuring module, configured to: when the domain identifier of the neighboring cell does not belong to one of the group consisting of the RA, the LA, and the TA in the camping forbidden list in the UE, select, according to the PLMNID, from the neighboring cell, a cell which belongs to an equivalent operator with the source cell as a cell to be measured, and measure the cell to be measured according to the measurement information, so as to obtain signal quality of the cell to be measured.

9. The user equipment according to claim 8, further comprising:
a reselecting module, configured to determine a cell whose signal quality is better than that of the source cell and is the best in the cells to be measured as a target cell, and reselect the target cell and camp on the target cell.

10. A user equipment, comprising:
a receiving module, configured to receive a system message sent by a base station, wherein the system message comprises measurement information, a public land mobile network identifier (PLMNID), and a domain identifier of a neighboring cell of a source cell accessed by the UE, the domain identifier is one of the group consisting of a routing area (RA), a location area (LA), and a tracking area (TA) of the neighboring cell, the source cell is controlled by the base station, and there is at least one neighboring cell;
a second measuring module, configured to measure the neighboring cell according to the measurement information, and obtain signal quality of the neighboring cell;
a second judging module, configured to select, according to the PLMNID, from the neighboring cell, a cell which belongs to an equivalent operator with the source cell and whose signal quality is better than that of the source cell as a cell to be measured, and judge whether a domain identifier of the cell to be measured belongs to one of the group consisting of an RA, and an LA, and a TA in a camping forbidden list in the UE; and
a second keeping module, configured to keep the UE camping on the source cell if the domain identifier of the cell to be measured belongs to one of the group consisting of the RA, the LA, and the TA in the camping forbidden list in the UE.

11. The user equipment according to claim 10, further comprising:
a second reselecting module, configured to: when the domain identifier of the cell to be measured does not belong to one of the group consisting of the RA, the LA, and the TA in the camping forbidden list in the UE, use a cell, signal quality of which is the best in the cell to be measured, as a target cell, wherein the UE reselects the target cell and camps on the target cell.
